(19) United States
(12) Patent Application Publication
(10) Pub. No.: US 2003/0234058 A1
(43) Pub. Date: Dec. 25, 2003

(54) Reinforced, self-closing pipe insulation device

(76) Inventor: William D. Tippins, Houston, TX (US)

Correspondence Address: SHERMAN D PERNIA, ESQ., PC, 1110 NASA ROAD ONE, SUITE 450, HOUSTON, TX, 77058-3310, US

(21) Appl. No.: 10/178,321

(22) Filed: Jun. 22, 2002

(51) Int. Cl. F16L 9/14

(52) U.S. Cl. 138/149; 138/151; 138/157

(57) ABSTRACT

A reinforced, self-closing pipe insulation device for thermally insulating long lengths of pipe has an insulation layer/panel capable of being rolled around the length of pipe to bring a first and a second longitudinal edge adjacent each other to form a tubular sleeve or sleeve encircling the outside of the pipe. The insulation sleeve is reinforced proximate its outer surface by a plurality of reinforcement strips. Each reinforcement strip is a self-coiling spring which has a straight configuration and a coiled configuration. The spring bias of the reinforcement strips cause a strip to coil along its length and coil-face when the straight configuration is deformed. The self-coiling spring reinforcement strips are disposed in a spaced pattern in a layer affixed to an outer planar surface of the insulation layer with their coil-faces directed toward the pipe being insulated and their lengths parallel to the width of the insulation layer. The reinforcement spring strips each having a length approximating the width of the insulation layer where it is disposed. The insulation layer/panel includes at least one layer of a high temperature resistant insulating material.

### FIELD OF THE INVENTION

The present invention is in the field of tubular insulation conduits or sleeves having a longitudinal seam for insulating pipes. More specifically, the present invention relates to such conduits or sleeves having multiple layers and combination elements for reinforcing and for holding together the adjacent longitudinal edges of the conduit/sleeve.

### BACKGROUND OF THE INVENTION

Various insulation products for insulating piping and fluid conduits are known and old in the art. Examples of some of these products include sleeves or panels made of polymeric foams such as polyurethane, rubber and similar polymers. Insulation products using polymeric foams can be made with varing degrees of rigidity or flexibility. Additionally, these materials typically have relatively good structural integrity and resistance to impact and water damage. However, because of their organic composition, use of polymeric insulating materials can be limited by their susceptibility to high temperatures. This can make them unsuitable for certain insulation applications. Fibrous mineral and glass (e.g., rock wool and fiberglass) insulating materials have long been used in the art and have excellent thermal insulating characteristics and resistance to high temperatures. However, they tend to have low mechanical strength and are susceptible to impact and water damage.

In view of these limitations, the field has been motivated to develop hybrid thermal insulators combining the beneficial characteristics of each of these two groups of insulating materials. For example, Plummer, U.S. Pat. No. 3,955,601, discloses a pipe or conduit insulator comprising an inner foil layer laminated to a layer of high efficiency fiberglass heat insulation, which is in turn laminated onto an outer layer of a spongy, elastomeric insulating material. Additionally, Plummer teaches a full metal jacket around the insulating materials to reinforce the insulation device and protect it from damage. However, although the full metal jacket may provide very good protection from impact damage, it can make long lengths of the device heavy and difficult to handle.

Another such example is Perstnev et al., U.S. Pat. No. 5,934,338, who disclose insulating a heated surface using a combination of organic and mineral based insulating material layers. The Perstnev et al. disclosure teaches using a layer of high temperature mineral fiber based insulating material adjacent a heat source, with the fibrous layer enveloped in a layer of organic foam based insulating material. The organic foam based insulating material layer taught by Perstnev et al. can reinforce and provide some protection to the underlying fibrous insulating layer, but the foam based layer itself is not further protected.

In a departure from the piping insulation field, Prescott discloses in U.S. Pat. No. 5,845,804 a beverage container insulating apparatus utilizing a section of a foam rubber insulating material. The Prescott apparatus uses two self-coiling spring strips to wrap the length of a foam rubber rectangle around a beverage container. However, the Prescott apparatus is intended to insulate a cool surface from the ambient environment, not a hot surface. The foam rubber material of the Prescott apparatus, because of its organic composition, is susceptible to high temperature and is not a suitable insulator in certain high heat applications.

Although the above devices may be useful for their intended purposes, it would be useful in the field to have an alternative high temperature pipe insulation product for insulating long lengths of piping, which alternative product is structurally reinforced to reduce impact damage, but relatively light weight. Also, it would be beneficial if the alternative product can be made substantially water proof, and can be quickly snapped into place on a length of pipe.

### SUMMARY OF THE INVENTION

The present invention is a reinforced, self-closing pipe insulation device and a method of use. The device relates to snap-on thermal insulation for wrapping piping, and the method relates to applying the insulation device to a length of pipe. The reinforced, self-closing pipe insulation device comprises a long, flexible insulation layer or panel made of an appropriate thermal insulating material, and a plurality of self-coiling reinforcement strips embedded in or affixed to a surface of the insulation layer or panel. The pipe insulation device of the present invention can assume either of two separate structural configurations: a planar configuration and a tubular conduit/sleeve configuration. The structural configuration of the pipe insulation device depends on the configuration of the self-coiling reinforcement strips, as explained below. The pipe insulation device is typically made to assume a planar configuration before or as it is installed on a length of piping to be insulated. The pipe insulation device is made to assume its tubular sleeve configuration as or after it is installed on the length of pipe.

When the present insulation device is in its planar or flattened configuration, the insulation layer or panel has a substantially oblong, planar configuration, with a length, a width, a thickness and two opposite planar surfaces perpendicular to the length and width, i.e., a planar ambient-surface and a planar pipe-surface. The insulation layer/panel has end edges perpendicular to its length and longitudinal edges parallel to its length. The insulation layer/panel is comprised of a thermal insulating material. It is the insulating material that defines the general configuration and dimensions of the insulation layer/panel.

The insulation layer/panel is flexible at least along its width, and capable of being rolled along its width to bring the longitudinal edges adjacent each other to form a tubular conduit or sleeve. The tubular conduit/sleeve thus formed by the insulation layer/panel has an interior-surface formed from the planar pipe-surface of the insulation layer, and an exterior-surface formed from the planar ambient-surface of the insulation layer. The planar pipe-surface of the tubular sleeve configuration of the present device is intended to closely interface with the length of pipe to be insulated.

The reinforcement strips are a plurality of self-coiling spring strips, such as are generally known and commercially available. See, for example, U.S. Pat. Nos.: 6,309,076; 5,971,612; and 3,410,023. Typically, such self-coiling spring strips are comprised of a prestressed strip of spring material, usually a metal like spring steel. The strips each normally form into a relatively constant radius coil around itself. Existing self-coiling spring strips exhibit a flat cross-section in the normally coiled configuration. As the strips are uncoiled and straightened, they take on an arcuate cross-section, which allows the spring strips to store their bias energy and maintain a straightened configuration.

The spring strips each have a strip-length, a strip-width, a concave or coil-face, and a convex or back-face. Additionally, the spring strips have a straightened configuration and a coiled configuration, and a normal bias to coil along its strip-length to assume its coiled configuration. The concave and convex faces are exhibited only when the spring strips are in the straightened configuration. A spring strip can exhibit either configuration at different positions along its strip-length, i.e., the spring strip can be partly coiled at one end and partly straightened at the other. When in the straightened configuration and spring strip is deformed (i.e., bent along its length in the direction of the convex face), the bias energy of the spring strip is released and causes the strip to coil along the convex face to assume its coiled configuration.

The plurality of self-coiling reinforcement spring strips are arrayed in a spaced pattern to form a reinforcement strip layer. The arrayed self-coiling reinforcement strips are affixed to or embedded in a planar surface of the insulation layer with their strip-lengths parallel to the width of the insulation layer/panel. The reinforcement strips each have a strip-length approximating the width of the insulation layer where it is disposed. The self-coiling reinforcement strips may have a strip-length that is less than or greater than the width of the insulation layer/panel where it is disposed. With each spring strip of the array in its straightened configuration, the insulation layer/panel is in its planar configuration. When the reinforcement spring strips are then deformed and biased to assume their coiled configuration, under the force of the spring bias, the device tends to roll-up along its width, bringing the longitudinal-edges of the insulation layer toward each other and forming a tubular conduit/sleeve. The axis of the tubular conduit/sleeve is parallel to the length of the insulation layer. When the self-closing pipe insulation device is made to assume its tubular sleeve configuration around a length of pipe having an appropriate outside diameter, the longitudinal-edges of the insulation layer are biased adjacent each other to form a tubular sleeve of thermal insulating material around the length of pipe. The reinforcement spring strips affixed to or imbedded in the insulation layer provide structural reinforcement for the device, and reduce the occasion of damage to the insulation layer from impact and the like.

The insulation layer or panel of the present self-closing pipe insulation device can be a laminate. For example, the insulation layer can comprise a cover sheet made of a flexible material over a thermal insulating material. For application of the present invention where it is desirable to protect the insulating material of the device from water damage, the cover sheet is made of a water proof material, as known in the art and described below. The cover sheet has a cover-width and a cover-length which are respectively parallel to the width and length of the insulation layer. The cover-width of the cover sheet typically is greater than the width of the insulation layer with which it interfaces, and extends beyond one of the longitudinal-edges of the insulation layer. This edge-flap is intended to lap over the joint between the adjacent longitudinal-edges of the insulation layer when the device is in its tubular sleeve configuration. The edge-flap provides a means for sealing the length of the tubular insulation sleeve by overlapping the joint. The edge-flap may be adhered to the outer cover surface by use of an adhesive, tape or the like to effect a seal. The underside of the flap, where it is to adhere to the outer cover may be pre-treated with an adhesive film which is protected prior to use by a release tape covering.

Optionally, the cover sheet of the pipe insulation device can have a cover-length that is greater than the length of the insulation layer and extends beyond one end of the insulation layer/panel to form an end-flap at that end. The end-flap is intended to lap over the butt-joint between the end-edges of adjacent self-closing pipe insulation devices in their tubular sleeve configuration. As with the edge-flap, the end-flap provides a means for sealing the butted end-edges of two lengths of the tubular insulation sleeve by overlapping the butt-joint between them. The end-flap may be adhered to the outer cover surface of the adjacent tubular sleeve by use of an adhesive, tape or the like. In the absence of an end-flap, the butted end-edges may be sealed using a water proof tape or other appropriate means known in the art.

The cover sheet can be made of a plastic film or sheeting (e.g., polyurethane and similar products) such as are known and in general use in the industrial arts. These materials are particularly useful when it is desired to protect the underlying insulating materials from water damage. The inner cover surface of the cover sheet interfaces with the thermal insulating material and forms the planar ambient-surface of the insulation layer. Where a cover sheet is incorporated in the device, the self-coiling strips can be arrayed between the inner-surface of the cover sheet and the insulating material or affixed to the outer-surface of the cover sheet. Alternatively, as noted above, the spring strip array layer may be embedded in the insulating material.

Also, the reinforced, self-closing pipe insulation device can include a heat-film covering at the planar pipe-surface of the insulation layer. As an example, a metal foil film can be used to cover the insulating material at the planar pipe-surface of the insulation layer. In this example, the heat-film comprises the interior-surface of the tubular sleeve configuration of the pipe insulation device.

The insulating material itself may be a laminate—comprising more than one layer of different insulating materials having different insulating and structural characteristics. For example, the insulating material layer at the planar pipe-surface of the insulation layer/panel may have a high thermal insulating coefficient, but relatively low structural integrity, such as rock wool or fiberglass batting. Whereas the insulating material at the planar ambient-surface of the insulation layer/panel, such as foam rubber or foam plastic, although having a relatively lower thermal insulating coefficient, provides greater structural integrity and a relatively more stable substrate for layering an insulating material like rock wool or fiberglass onto.

It can be a problem when the intended application for the pipe insulation device requires that the insulation layer/panel comprise rigid insulating materials or insulating materials having a thickness that hampers or precludes rolling the insulation layer along its width to properly form a tubular insulation sleeve. A properly formed insulation sleeve has longitudinal-edges that interface evenly and form a longitudinal joint seam that is substantially as insulating as the rest of the sleeve. When rigid or thick insulating materials comprise the insulation layer, the cross-section of the layer/panel through its width may be modified to permit the layer/panel to be rolled to form a tubular insulation sleeve. For example, for a device having a thick insulating material, the layer/panel cross-section can be made trapezoidal to facilitate even joining of the adjacent longitudinal-edges when the panel is rolled to form the tubular sleeve configuration.

When the pipe insulation device comprises an insulation layer/panel utilizing a relatively rigid insulating material, the insulating material can be divided into insulating bats, having a bat-length equal to the length of the insulation layer/panel. Additionally, each insulation bat has a symmetric trapezoidal cross-section with the short parallel side of the trapezoid defining planar pipe-surface bat-width of the bat and the long parallel side defining the planar ambient-surface bat-width. Also, the bats each have a first and a second longitudinal bat-edge defined by the symmetric non-parallel sides of the trapezoidal cross-section. The insulating material bats are juxtaposed with their bat-lengths in parallel. The insulating bats are held in their parallel juxtaposition by the spring strips embedded in or adhered to the ambient-surfaces of the insulating bats. Alternatively or additionally, a cover sheet adhered to the ambient-surface of the insulating bats can further hold the bats in their parallel juxtaposition. In such a configuration, the spring strips may be disposed in the insulation layer, on the insulation layer or on the cover sheet. The flexibility of the spring strips and cover sheet allow the insulation panel to be rolled along its width to form the tubular sleeve configuration of the present invention. The number of insulating bats and the angle of their non-parallel sides are selectable by one of ordinary skill in the art in view of the outside diameter of the pipe with which the pipe-surface of the tubular sleeve is to closely interface.

When using the reinforced, self-closing pipe insulation device to insulate a length of pipe the self-coiling strips of the pipe insulation device are formed into their straight configuration and the device is set in its planar configuration. Then one end of the pipe insulation device is positioned with its planar pipe-surface against the pipe to be insulated: width of the device perpendicular to the length of the pipe. Then the self-coiling spring strips in the part of the pipe insulation device contacting the pipe are caused to take their coiled configuration. The bias force of the spring strips causes the device to form its tubular sleeve configuration, with the tubular sleeve's interior surface surrounding and interfacing with the outer surface of the length of the pipe.

When the insulation layer of the device is flexible along its length as well as its width, the planar configuration of the device may be rolled up along its length to form a roll of pipe insulation. The roll configuration of the pipe insulation device can facilitate storage and handling of the device by enabling it to be compacted relative to its length dimension.

### BRIEF DESCRIPTION OF THE DRAWINGS

FIG. 1A is perspective view of a portion of a reinforced, self-closing pipe insulation device of the present invention shown in its planar configuration and in position to be installed on a length of pipe.

FIG. 1B is perspective view of a portion of a reinforced, self-closing pipe insulation device of the present invention shown in its tubular conduit/sleeve configuration installed on a length of pipe.

FIGS. 2A and 2B are perspective views of a prior art self-coiling spring strip practicable in the present invention as the reinforcement strip. The reinforcement spring strip is shown in its straightened configuration (A), and in its partially coiled configuration (B).

FIG. 3A is a perspective view of a portion of a reinforced, self-closing pipe insulation device of the present invention shown in its planar configuration and having a cover sheet and edge-flap.

FIG. 3B is perspective view of a portion of a reinforced, self-closing pipe insulation device of FIG. 3A shown in its tubular conduit/sleeve configuration installed on a length of pipe with the edge-flap ready to be adhered.

FIG. 4 is a perspective view showing portions of two reinforced, self-closing pipe insulation devices in their tubular sleeve configuration installed on a length of pipe. The tubular insulation sleeve are end-butted together with the edge-flap and end flap of the distal sleeve ready to be adhered to the outer cover of the proximal device.

FIG. 5 is a cross-sectional end view of a reinforced, self-closing pipe insulation device in its tubular sleeve configuration installed around a length of pipe. In this example of the present invention, the pipe insulation device has a cover sheet with cover flap and reinforcement spring strips that are fixed to the outside face of the cover sheet.

FIG. 6 is a cross-sectional end view of a portion of a reinforced, self-closing pipe insulation device in its tubular sleeve configuration installed around a length of pipe. In this example, the pipe insulation device has a cover sheet with cover flap adhered in place and the reinforcement spring strips embedded in the ambient-surface of the insulating material. Additionally, this example of the pipe insulation device includes a heat film covering at the pipe surface.

FIGS. 7A and 7B are partial perspective drawings illustrating adapting the insulation layer or panel of the present pipe insulation device to accommodate a relatively rigid insulating material.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

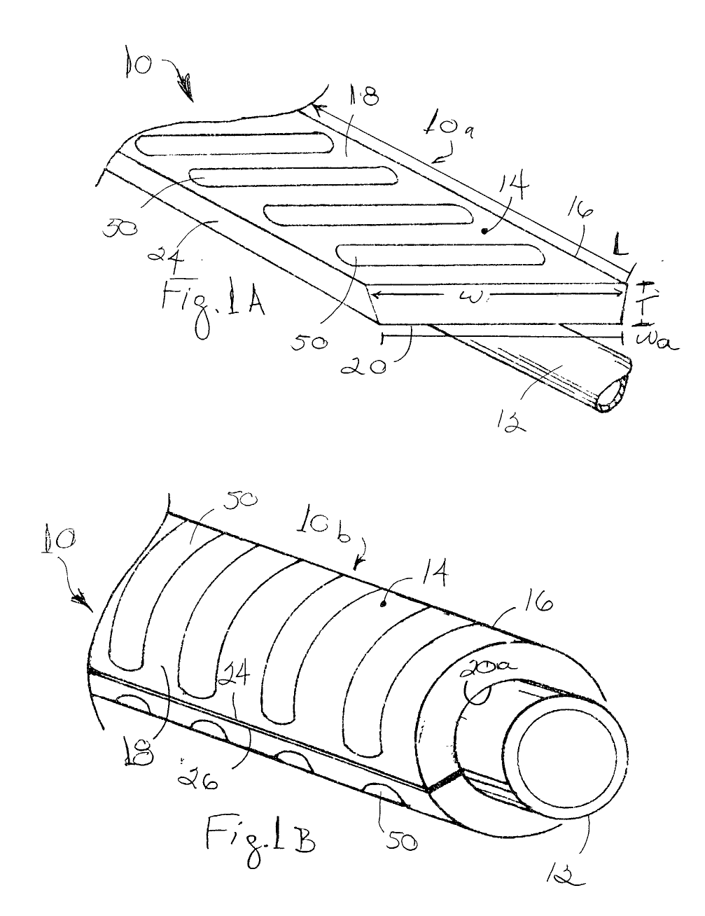

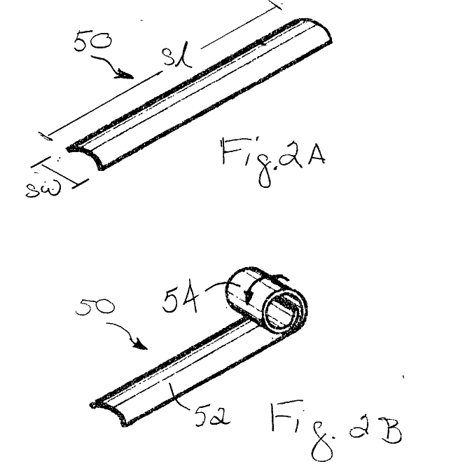

As shown in FIGS. 1A and 1B, the present invention is a reinforced, self-closing pipe insulation device 10 for thermally insulating a length of pipe 12. The pipe insulation device has two separate structural configurations: a flat or planar configuration 10a (FIG. 1A) and a tubular sleeve configuration 10b (FIG. 1B). The structural configuration of the pipe insulation device 10 depends on the configuration of the self-coiling reinforcement spring strips 50 and whether their inherent spring bias is stored (the strips are straightened) or released (the strips are un-straightened).

As exemplified in FIG. 1A, the present reinforced, self-closing pipe insulation device 10 comprises an insulation layer or panel 14, which is flexible at least along its width W, and made of an appropriate thermal insulating material 16. The insulation device 10 also includes a plurality of self-coiling reinforcement strips 50 affixed (in the example illustrated) to the outer or ambient-surface 18 of the insulation layer/panel 14. The insulation layer/panel 14 has a substantially oblong and planar configuration including a length L, one or two widths W & Wa, a thickness T and two opposite planar surfaces perpendicular to the thickness T. One of the layer surfaces is an ambient-surface 18 (i.e., distal to the pipe being insulated) and a pipe-surface 20 (i.e., proximal the pipe being insulated). It is anticipated that for commercial reasons, the length L of the insulation panel/layer 14 will be at least about one foot long.

The insulation layer 14 is flexible at least along its width W, and is capable of being rolled along its width W to bring a first longitudinal edge 24 adjacent its second longitudinal edge 26 to form a tubular sleeve 10b, the tubular sleeve 10b having an interior surface 20a (formed from the pipe surface 20) for interfacing with the length of pipe 12.

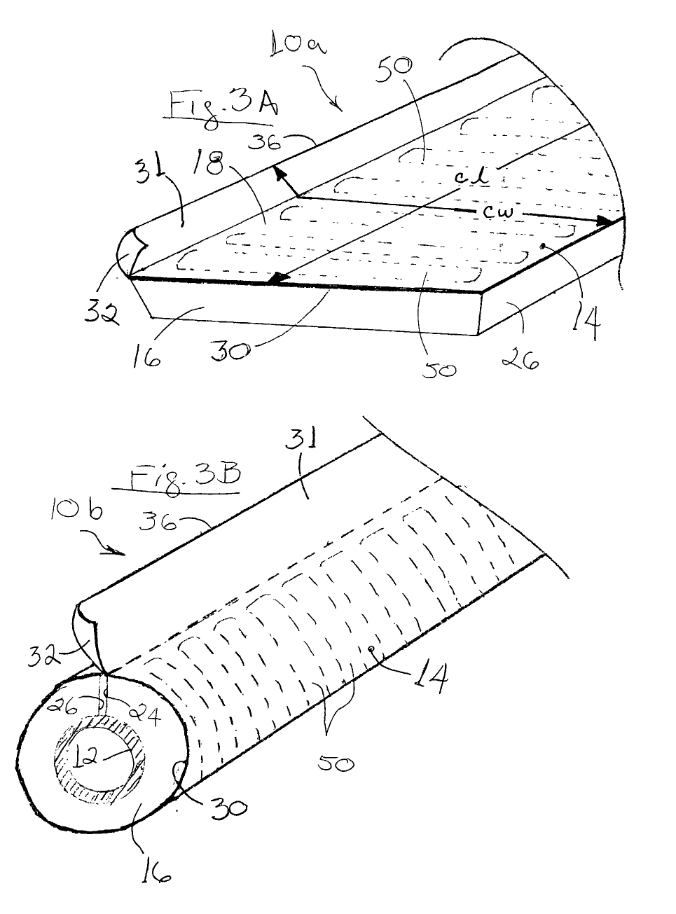

As also shown in FIGS. 1A and 1B, the pipe insulation device includes a plurality of self-coiling reinforcement spring strips 50. Self-coiling spring strips 50 practicable in the present invention are known in the art and are commercially available (e.g., cross-curved Snap Tape™, Vulcan Spring & Mfg., Co, Telford, Pa.). As shown in FIGS. 2A and 2B, each spring strip 50 has a strip-length sl, a strip-width sw, a coil/convex-face 52, a back/concave-face 54. As also shown, each spring strip 50 has a straight configuration (FIG. 2A), a coiled configuration (not shown), and a bias (see arrow, FIG. 2B) to coil along its strip-length sl and coil-face 52 when the straight configuration is deformed.

The self-coiling, reinforcement spring strips 50 are disposed in a spaced manner in a strip layer and incorporated into the pipe insulation device 10 with their strip-lengths parallel to the width W of the insulation layer 14. The reinforcement strips 50 are spaced along the L of the insulation layer 14 at intervals of two to four times the strip-width sw of the reinforcement strips 50. The spring strips 50 each have a strip-length sl approximating the width W of the insulation layer 14 where it is disposed. In the preferred embodiment of the pipe insulation device 10, the insulation layer 14 is oblong to encircle a length of pipe 12 of substantially constant diameter and the strip-length sl of the spring strips are all substantially the same. However, for an application where there is a change (not shown) in diameter of the pipe 12 to be insulated, the width W of the insulation layer 14 and the strip-length si of the spring strips 50 associated with the changed diameter pipe will be different from the rest of the device 10 to accommodate the change in pipe diameter.

The self-coiling spring strips 50 of the present pipe insulation device are affixed to a planar surface of the insulation layer 14 or embedded in the insulation layer 14 itself. In the preferred embodiment exemplified in FIGS. 1A and 1B, the spring strips 50 are affixed to the ambient surface 18 of the insulation layer. The reinforcement spring strips 50 can be affixed to the ambient surface by any of a number of means known to the ordinary skilled artisan, including an adhesive, heat fusion, etc.

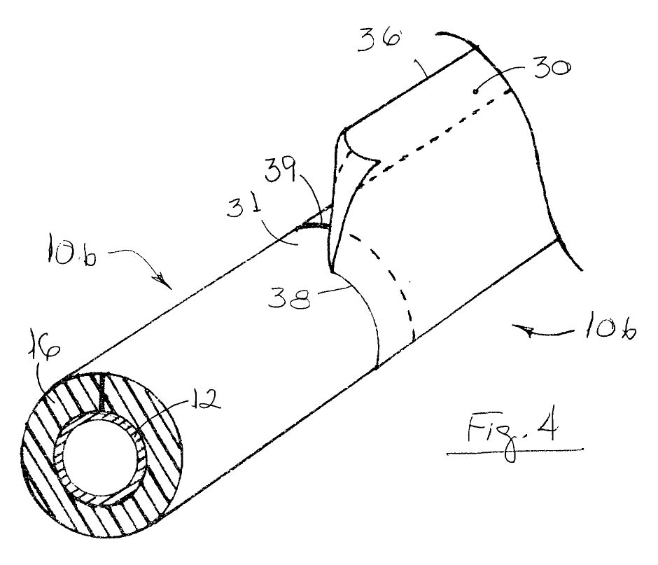

In another preferred embodiment of the pipe insulation device 10, the insulation layer 14 is a laminate. As shown in the preferred embodiment exemplified in FIGS. 3A and 3B, the insulation layer 14 is a laminate comprising a cover sheet 30 made of a flexible material laid over at least one layer of a thermal insulating material 16. The cover sheet 30 has a cover-width cw and a cover-length cl which are respectively parallel to the width W and length L of the insulating material 16. The cover sheet 30 has an outer cover-surface 31 and an inner cover-surface 32. The insulating material 16 define the configuration and dimensions of the insulation layer 14 and having a planar ambient surface 18 with which the inner surface 32 of the cover sheet 30 interfaces and a planar pipe surface 20.

Although the cover sheet may be the same length and width as the insulating layer 16, in the preferred embodiment exemplified in FIGS. 3A and 3B, and the cover-width cw of the cover sheet 30 is greater than the width W of the insulating material 16 and extends beyond one of the longitudinal edges 24 of the insulating material 16. This edge-flap 36 is intended to lap over the joint between the adjacent longitudinal-edges 24 & 26 of the insulating material when the device 10 is in its tubular sleeve configuration 10b. The edge-flap 36 provides a means for sealing the length of the tubular insulation conduit/sleeve 10b at the joint between the adjacent longitudinal-edges 24 & 26 of the insulating material by overlapping the joint. The edge-flap 36 may be adhered to the outer cover surface 31 by use of an adhesive, tape or the like (not shown) to effect a seal.

FIG. 4 shows two reinforced, self-closing pipe insulation devices in their tubular conduit/sleeve configuration 10b installed on a length of pipe 12. The tubular insulation conduits/sleeves 10b are end-butted together with the edge-flap 36 and end-flap 38 of the distal sleeve ready to be adhered. Optionally, as shown in FIG. 4, the cover sheet 30 of the pipe insulation device can have a cover-length cl that is greater than the length L of the thermal insulating material 16 and extends beyond one end of the insulating material 16 to form an end-flap 38 at that end. The end-flap 38 is intended to lap over the butt-joint 39 between the end-edges of adjacent self-closing pipe insulation devices 10 in their tubular sleeve configuration. As with the edge-flap 36, the end-flap 38 provides a means for sealing the joint between the butted end-edges of two lengths of the tubular insulation sleeve 10b by overlapping the butt-joint 39 between them. The end-flap 38 may be adhered to the outer cover surface 31 of the adjacent tubular sleeve by use of an adhesive, tape or the like. Alternatively, the joint between the butted end-edges may be sealed with an appropriate type of adhesive tape (e.g., duct tape) as is known in the art.

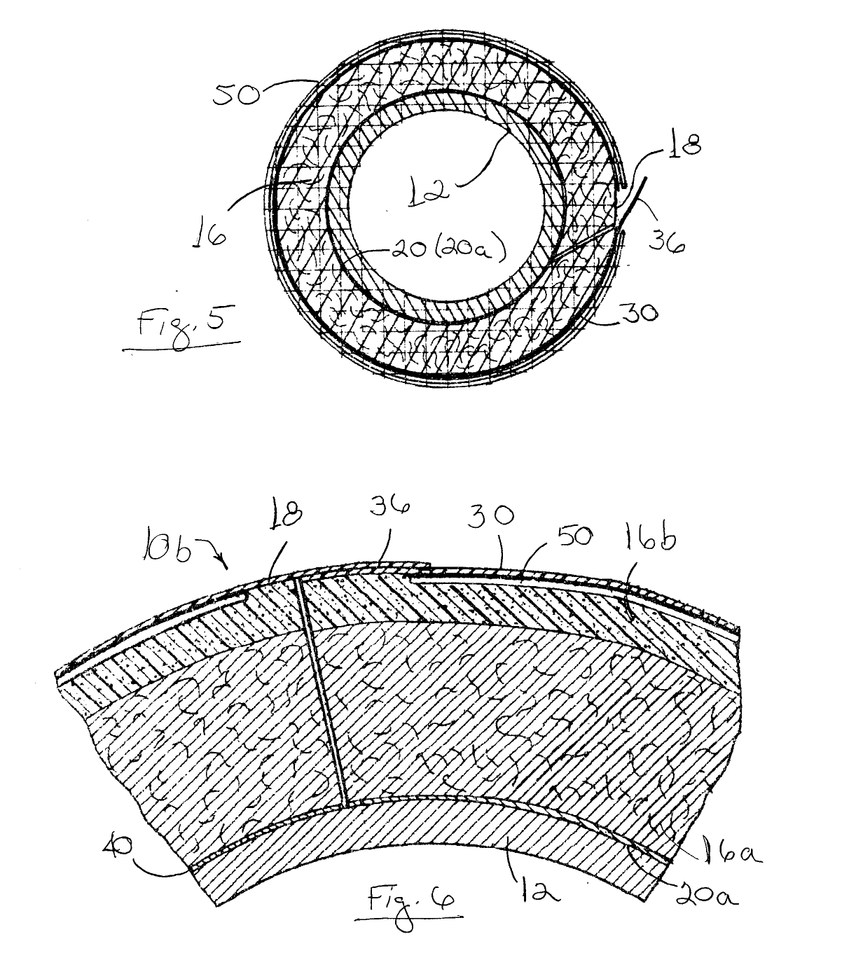

In the preferred embodiment exemplified in FIGS. 3A and 3B, the self-coiling strips 50 (shown in phantom) are arrayed in a strip layer disposed between the inner cover-surface 32 of the cover sheet 30 and the insulating material 16. Although in this embodiment the self-coiling strips 50 are arrayed in strip layer and fixed to the inner cover-surface 32 of the cover sheet 30, alternatively, the self-coiling strips 50 could have been disposed in a strip layer fixed to the outer cover surface 31 of the cover sheet 30 (see FIG. 5).

The insulating material 16 itself can be a laminate comprising a plurality of insulating material layers having different insulating characteristics. For example, FIG. 6 shows a cross-sectional end view of a portion of a reinforced, self-closing pipe insulation device 10 in its tubular sleeve configuration 10b installed around a length of pipe 12. The insulating material layer 16a proximal the interior surface 20a of the tubular sleeve 10b has a high thermal insulating coefficient, but relatively low structural integrity, such as with rock wool or fiberglass batting. Whereas the insulating material layer 16b at the ambient-surface 18 of the tubular sleeve 10b, such as with foam rubber or foam plastic, has greater structural integrity, but a relatively lower thermal insulating coefficient, providing a relatively more stable substrate on which to layer an insulating material like rock wool or fiberglass.

Additionally, in the embodiment exemplified in FIG. 6, a heat-film 40 (e.g., a metal foil, as is known and used in the art) is used to cover the interior pipe-surface 20a of the insulation layer 16a at the interior surface 20a of the tubular sleeve 10b. In this example, the heat-film comprises the interior-surface 20a of the tubular sleeve 10b of the pipe insulation device and helps to stabilize the fibrous insulating material depicted.

When the insulation layer/panel 14 comprises insulating materials 16 having an excessive thickness T, the thickness can hamper or preclude rolling the insulation layer along its width W to form a proper tubular insulation sleeve 10b. A proper tubular sleeve configuration 10b has longitudinal-edges 24 & 26 that interface evenly and form a longitudinal joint that is substantially as insulating as the rest of the sleeve. When a thick insulating material 16 comprises the insulation layer 14, the cross-section of the layer/panel 14 through its width W may be modified to permit the layer/panel 14 to be more readily rolled to form a tubular insulation sleeve 10b. For example, as shown in FIGS. 1A and 3A, in a pipe insulation device 10 having a thick insulation layer/panel 14, the cross-section of the layer/panel 14 can be made trapezoidal to facilitate even joining of the adjacent longitudinal-edges when the panel is rolled to form the tubular sleeve configuration. Also, as shown in FIG. 5, the configuration of the longitudinal-edges 24 & 26 can be adapted to improve the thermal characteristics of the longitudinal joint formed between the two in the tubular sleeve configuration 10b.

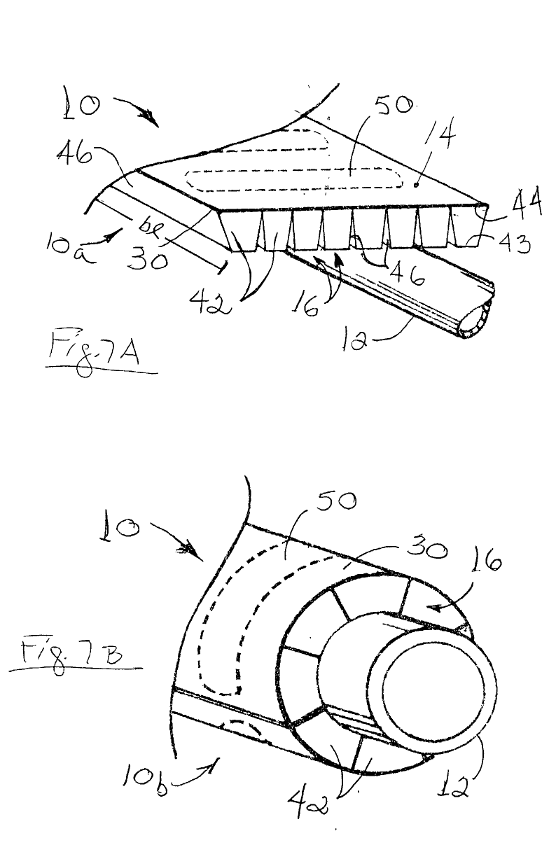

FIGS. 7A and 7B illustrate adapting the insulation layer or panel 14 of the present pipe insulation device 10 to accommodate a relatively rigid insulating material 16. When the pipe insulation device 10 comprises an insulation layer/panel 14 utilizing a relatively rigid insulating material 16, the insulating material 16 can be divided into insulating bats 42, each insulating bat 42 having a bat-length bl equal to the length L of the insulation layer/panel 14. Additionally, each insulation bat 42 has a symmetric trapezoidal cross-section with the short parallel side of the trapezoid defining the bat pipe-surface 43 of the bat 42, and the long parallel side defining the bat ambient-surface 44 of the bat 42. Also, the bats 42 each have a first and a second longitudinal bat-edge 46 defined by a symmetric non-parallel side of the trapezoidal cross-section. The insulating material bats 42 are juxtaposed with their bat-lengths bl in parallel. The insulating bats 42 are held in their parallel juxtaposition by the spring strips 50 embedded in or adhered to the ambient-surfaces of the insulating bats 42. Alternatively, or additionally as shown in the preferred embodiment of FIGS. 7A and 7B, a cover sheet 30 is adhered to the ambient-surfaces 44 of the insulating bats 42 to further hold the bats in their parallel juxtaposition. The flexibility of the spring strips 50 and cover sheet 30 allow the insulating bats 42 to be rolled to form the tubular sleeve configuration 10b shown in FIG. 7B. The number of insulating bats 42 and the angle of their non-parallel sides are selectable by one of ordinary skill in the art in view of the outside diameter of the pipe 12 with which the pipe-surface 20 of the tubular sleeve 10b is to closely interface. Generally in the preferred embodiments, spring strips 50 may be disposed within the insulation layer 14, on the ambient surface of the insulation layer 14 or on the cover sheet 30.

### EXAMPLE 1

### Device for Insulating a 1 Inch o.d. Pipe

An insulating material layer of a fibrous insulating material (rock wool, FIBREX FBX 1240™, Fibrex Insulations, Inc., Ontario, Canada) was prepared: ˜9 inches wide by 30 feet long and 1 inch thick.

The fibrous insulating material layer was laid out flat and the top planar surface (ambient surface) was spray coated with an adhesive (SUPER 77™, Multipurpose Adhesive, 3M Company).

Self-coiling spring strips (SNAP TAPE™, Vulcan Spring & Mfg. Co., Pa.) ˜8.75 inches long and 1 inch wide were set in their straightened configuration and arrayed on the adhesive coated ambient surface of the insulating material layer: spaced 1 inch with their lengths in parallel with each other and with the with the width of the insulation material layer.

The ambient surface of the insulating material layer (and arrayed spring strips) was again spray coated with adhesive.

A cover sheet was prepared from a polyurethane film material, and laid over and adhered to the ambient surface of the insulating material layer (and arrayed spring strips).

The cover sheet was close trimmed along the two width ends and one long side of the insulating material layer, and a flap ˜2 inches wide was left on the remaining long side of the insulating material layer.

The reinforced, self-closing pipe insulation device thus constructed was rolled from one end down its length to form a rolled configuration for storage, and to facilitate installing it on a length of pipe.

When using the reinforced, self-closing pipe insulation device 10 to insulate a length of pipe 12, the self-coiling strips 50 of the pipe insulation device 10 are first straightened, and the pipe insulation device 10 is set in its planar configuration 10a. Then the planar configured device 10a is positioned with its planar pipe-surface 20 against the pipe 12 to be insulated, with the width W of the device 10a perpendicular to the length of the pipe. Then the self-coiling spring strips 50 in the part of the pipe insulation device 10a contacting the pipe 12 are caused to take their coiled configuration. The bias force of the spring strips 50 causes the pipe insulation device 10 to form its tubular sleeve configuration 10b, with the tubular sleeve's interior/pipe surface 20 surrounding and interfacing with the length of the pipe 12.

In the preferred embodiments illustrated in FIGS. 1A and 1B and FIGS. 3A and 3B, the insulation layer 14 of the device 10 is flexible along its length L as well as its width W. In embodiments such as these, the planar configuration of the device 10 may be rolled up along its length L to form a roll (not shown) of pipe insulation. The roll configuration of the pipe insulation device 10 is similar to rolled thermal insulation configuration currently known and used in the industrial and construction arts. Configuring the device 10 in a roll can facilitate storage and handling of the device 10 by enabling it to be compacted relative to its length L dimension. A further benefit of this capability is that these embodiments of the present insulation device 10 can be readily installed around bends or angles in the piping on which it is installed.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A reinforced, self-closing pipe insulation device for thermally insulating a length of pipe comprising:
an insulation layer having a substantially oblong planar configuration including a length, a width, a thickness and two opposite planar surfaces perpendicular to the width, one being an ambient surface and the other being a pipe surface, the insulation layer capable of being rolled around the length of pipe to bring a first longitudinal edge adjacent a second longitudinal edge to form a tubular sleeve, the tubular sleeve having an interior surface formed from the pipe surface of the insulation layer and interfacing with the length of pipe to be insulated; and
a plurality of at least three of reinforcement strips, each reinforcement strip being a self-coiling spring strip having a strip-length, a strip-width, a coil-face, a back-face, a straight configuration, a coiled configuration, and a bias to coil along its strip-length and coil-face when the straight configuration is deformed, the self-coiling strips disposed in a spaced manner in a strip layer affixed to a planar surface of the insulation layer with their coil-face directed toward the pipe surface, and their strip-lengths parallel to the width of the insulation layer, and the strips each having a strip-length approximating the width of the insulation layer where it is disposed.

2. The pipe insulation device of claim 1, wherein the insulation layer comprises a high temperature resistant insulating material.

3. The pipe insulation device of claim 1, wherein the insulation layer is a laminate comprising:
a cover sheet made of a flexible material having an inner cover surface and an outer cover surface; and
at least one insulating material layer of a high temperature resistant insulating material, the insulating material defining the configuration and dimensions of the insulation layer and having a planar ambient surface and a planar pipe surface, with the planar ambient surface interfaced with the inner cover surface of the cover sheet.

4. The pipe insulation device of claim 3, wherein the self-coiling strips of the strip layer are disposed between the inner cover surface of the cover sheet and the ambient surface of the planar ambient surface of the insulation layer.

5. The pipe insulation device of claim 3, wherein the self-coiling strips of the strip layer are fixed to a surface of the cover sheet.

6. The pipe insulation device of claim 3, wherein the self-coiling strips of the strip layer are disposed at the outer cover surface of the cover sheet.

7. The pipe insulation device of claim 3, wherein the insulation layer is a laminate comprising more than one insulating material layer.

8. The pipe insulation device of claim 3, wherein the insulation layer is a laminate comprising a plurality of insulating material layer having different insulating characteristics.

9. The pipe insulation device of claim 3, wherein the cover sheet has a cover width and a cover length which are respectively parallel to the width and length of the insulation layer.

10. The pipe insulation device of claim 9, wherein the cover sheet has a cover width and a cover length which are respectively parallel to the width and length of the insulation layer, and the cover width of the cover sheet is greater than the width of the insulation layer and extends beyond one of the longitudinal edges of the insulation layer.

11. The pipe insulation device of claim 9, wherein the cover sheet has a cover width and a cover length which are respectively parallel to the width and length of the insulation layer, and the cover length of the cover sheet is greater than the length of the insulation layer and extends beyond the length of the insulation layer.

12. The pipe insulation device of claim 1, wherein the insulation layer, is a laminate comprising:
a cover sheet made of a flexible material having an inner cover surface and an outer cover surface; and
an insulating material layer of an insulating material, the insulating material defining the configuration and dimensions of the insulation layer and having a planar ambient surface and a planar pipe surface, with the planar ambient surface interfaced with the inner cover surface of the cover sheet, and the insulating material layer further comprising a plurality of insulating material bats, each bat having a bat-length substantially equal to the length of the insulation layer a symmetric trapezoidal cross-section with the short parallel side defining a planar pipe surface width of the bat and the long parallel side defining a planar ambient surface, and the bats each having a first and a second longitudinal bat-edge defined by a symmetric nonparallel side of the trapezoidal cross-section, the insulating material bats juxtaposed with their bat-lengths in parallel.

13 The pipe insulation device of claim 1, wherein the insulation layer, is flexible along its length and rollable along its length to form the device into a rolled configuration.

14. A method for insulating a pipe comprising:
providing a length of a self-closing pipe insulation device of claim 1 having self coiling strips;
configuring the self-coiling strips of the pipe insulation device into a straight configuration;
positioning an interior surface of at least a part of a length of the pipe insulation device adjacent to and in parallel with a length of a pipe to be insulated; and
causing the self-coiling strips in the part of the pipe insulation device adjacent the pipe to take a coiled configuration, and form a tubular sleeve, the tubular sleeve having an interior surface surrounding and interfacing with the length of the pipe.
